(19) United States
(12) Patent Application Publication
(10) Pub. No.: US 2002/0143617 A1
(43) Pub. Date: Oct. 3, 2002

(54) Printing device replaceable component having memory to store data used to develop marketing solutions and method for use

(76) Inventors: Michael J. Borg, Boise, ID (US); Alysia F. Wurst, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/820,453

(22) Filed: Mar. 28, 2001

(51) Int. Cl. G06F 17/60

(52) U.S. Cl. 705/14; 705/1

(57) ABSTRACT

Systems, methods and data structures are described for collecting data in component memory of a printing device replaceable component and utilizing the data to provide marketing solutions for potential customers. A printing device records data related to the printing device, usage information, environment information, etc. in a memory tag of a replaceable component—such as a toner cartridge—used in the printing device. When the component is returned to the manufacturer for recycling, the information is retrieved from the memory tag and stored in a marketing database. The marketing database is searched for printing devices that meet certain search criteria. A customer is identified as using or owning the printing device, and marketing information is delivered to the customer. The marketing information is related to the customer's printing device and usage thereof.

### TECHNICAL FIELD

The systems and methods that are described herein relate generally to managing data collected from printing devices. More particularly, the systems and methods described herein relate to a printing device replaceable component with memory that is used to store printing device data, which is ultimately used to develop marketing solutions.

### BACKGROUND

In a free market economy, where consumer markets are driven by competition between providers of goods, a provider wishing to compete for consumer business must make potential customers aware of the advantages and benefits of the provider's product or service. Such a provider must rely on effective marketing campaigns to educate potential customers about the product.

Designing an effective marketing campaign is necessarily limited by the means of the provider to fund advertising. Since virtually all providers have limited funds available for advertising, it is important to employ an advertising strategy that is efficient as well as effective.

Identifying consumers of similar products who might use the provider's product (the relevant market) and delivering a message about the product to as many such consumers as possible is the goal of an advertising campaign. Indirect marketing techniques—such as television commercials and magazine advertisements—are methods through which a provider delivers one advertising message that may reach many potential customers. While indirect marketing is common, the most efficient delivery of an advertising message is through direct marketing. With direct marketing, the provider delivers one advertising message for each identified potential customer that the provider plans to reach. This makes the most efficient use of the provider's funds spent on advertising.

For example, when a provider pays for a television commercial to advertise his product, he cannot definitively know how many likely consumers of his product he will reach with the advertisement. While the provider may rely on statistics to determine how many people receive the message, it is impossible for the provider to know how many people receiving the message are within the relevant market and how many are not. Direct marketing has the advantage that the provider can be assured that all the money being spent on advertising is going to delivering the message to the consumers who are likely to be in the relevant market.

Manufacturers of printing devices such as printers, fax machines, copiers, etc., and replacement parts for such devices face the same marketing problems as any other provider in a competitive market. However, such manufacturers have a slight advantage in that, when a sale of such a device is made, one or more replaceable components will inevitably be required for the device, such as toner cartridges, drums, etc.

This knowledge provides an advantage to a manufacturer of such a product in that it limits the scope of marketing solutions provided for certain products and customers. However, it is desirable to narrow the marketing effort to an even more focused group of potential customers for a particular product.

### SUMMARY

The systems and methods for utilizing printing device data in a customer service center that are described herein provide improved ways in which a provider may gather information about potential customers so that marketing solutions may be developed that specifically target those potential customers.

It is noted that the systems and methods described herein may be applied with any type of product, such as a printing device, that utilizes replaceable components. Such products include, but are not limited to, printing devices, such as laser printer, ink jet printers, electro-thermographic printers, dry medium printers, ribbon printers, facsimile machines that utilizes any of the previously mentioned printing methods, copy machines that utilize such printing methods, and the like. Replaceable components for such printing devices include, but are not limited to, toner cartridges, ink cartridges, imager drums, fusers, and the like. For discussion purposes, the systems and methods described herein will refer to a laser printer and a toner cartridge, although it should be understood that the systems and methods may be utilized with any printing device and replaceable component for the printing device.

In an example of a customer purchasing a printer from a printer manufacturer, the initial data about the customer is received when the customer returns a registration card that contains personal information about the customer, information about the types of products used by the customer, and other similar information. A file or record for that customer is set up in a marketing database maintained by the manufacturer. In the future, replaceable components for the printer, such as toner cartridges, are sold and delivered to the customer. The replaceable components include a memory tag, which is used to record data from the printer. When a toner cartridge is exhausted, the customer returns it to the manufacturer for recycling. The manufacturer receives the cartridge, and the data is retrieved from the memory tag on the toner cartridge and data is stored in the marketing database. Appropriate links to other records that are related to the same customer or a similar product are established with the new data.

The memory tag on the toner cartridge collects virtually any type of printer data, such as the model number and serial number of the printer in which the cartridge is used, page coverage data, duplex usage data, number of pages printed by the printer, number of pages printed from the toner cartridges, etc. In addition to this data, the manufacturer may also test returned cartridges that are suspected of having faults or as part of a quality control measure. Data regarding reliability or the toner cartridge can be gained by this type of testing and may be added to the marketing database and linked to customers who use the same type of toner cartridge. Appropriate solutions for unreliable products may then be marketed to such customers.

Marketing solutions are also stored in the marketing database and linked to the printer or, in some cases, to the customer. For example, certain product/usage scenarios are developed that are determined to be optimum for certain marketing solutions. Suppose that it has been found that under high use conditions, toner cartridge ‘A’ experiences an unusually high number of problems. The marketing database can be processed to find customers that use toner cartridge ‘A’ in high usage situations. The manufacturer can then notify these customers that toner cartridge ‘B’ is more reliable under the customers' usage situations.

With such a system in place, a manufacturer can collect usage data retrieved from replaceable components returned to the manufacturer and use this data to identify particular customers that may be in a situation that make them more likely to purchase certain products produced by the manufacturer. The customer is thereby more satisfied with the printer purchased from the manufacturer and will more likely buy from the manufacturer again. A long-term relationship between the customer and the manufacturer can be established, which will result in increased sales to the customer.

### BRIEF DESCRIPTION OF THE DRAWINGS

A more complete understanding of exemplary methods and arrangements of the invention may be had by reference to the following detailed description when taken in conjunction with the accompanying drawings wherein:

FIG. 1 is an illustration of a laser printer toner cartridge having integrated memory.

FIG. 2 is a depiction of a system for utilizing printing device data with a marketing center.

FIG. 3 is a representation of a marketing database that stores data retrieved from memory of printing device replaceable components used in printing devices owned by several customers.

FIG. 4 is a flow diagram depicting a method for retrieving data from toner cartridge memory to store in a marketing database.

FIG. 5 is a flow diagram depicting a method for processing a marketing database that contains data from memory of toner cartridges, to assist with a marketing solution.

### DETAILED DESCRIPTION

The invention is illustrated in the drawings as being implemented in a suitable computing environment. Although not required, the invention will be described in the general context of computer-executable instructions, such as program modules, to be executed by a computing device, such as a personal computer, a hand-held computer or portable electronic device. Generally, program modules include routines, programs, objects, components, data structures, etc., that perform particular tasks or implement particular abstract data types. Moreover, those skilled in the art will appreciate that the invention may be practiced with other computer system configurations, including multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

General reference is made herein to one or more printing device. As used herein, “printing device” means any electronic device having data communications and data storage capabilities, and functions to render printed characters on a print medium. A printing device may be a printer, fax machine, copier, plotter, and the like. The term “printer” includes, but is not limited to, laser printers, ink jet printers, dot matrix printers, dry medium printers, copiers, facsimile machines and plotters. Although specific examples may refer to one or more of these printers, such examples are not meant to limit the scope of the claims or the description, but are meant to provide a specific understanding of the described implementations.

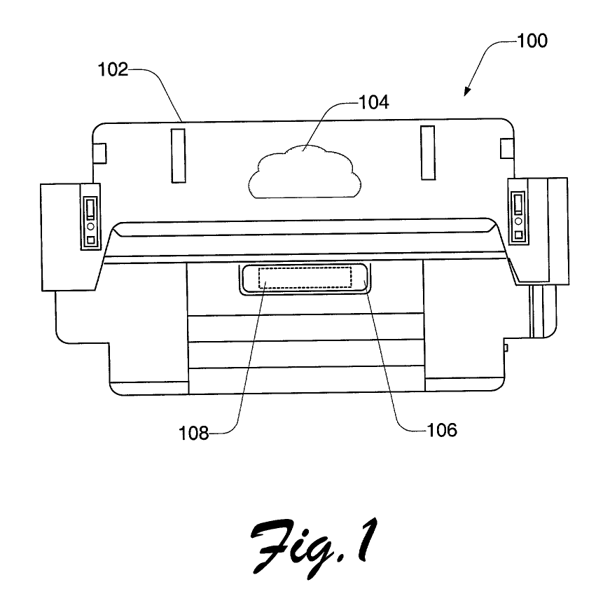

FIG. 1 is an illustration of a toner cartridge 100 that for a laser printer (not shown). The toner cartridge 100 is particularly suited for the present invention and includes a housing 102 and a toner reservoir 104 that may be filled with laser printer toner. The toner cartridge 100 also includes a label 106 that contains information identifying the toner cartridge 100 to a user. The label 106 typically recites the name of the manufacturer, the model number of the cartridge, etc.

A memory tag 108 is located underneath the label 106 on the toner cartridge 100, although the memory tag 108 may be placed on the toner cartridge 100 at any location that may be practical for the purposes described herein. The memory tag 100 is preferably a radio frequency identification (RFID) memory tag. RFID memory tags and applications therefor are well known in the art. Further aspects of the RFID memory tag 108 will become clear as the discussion progresses.

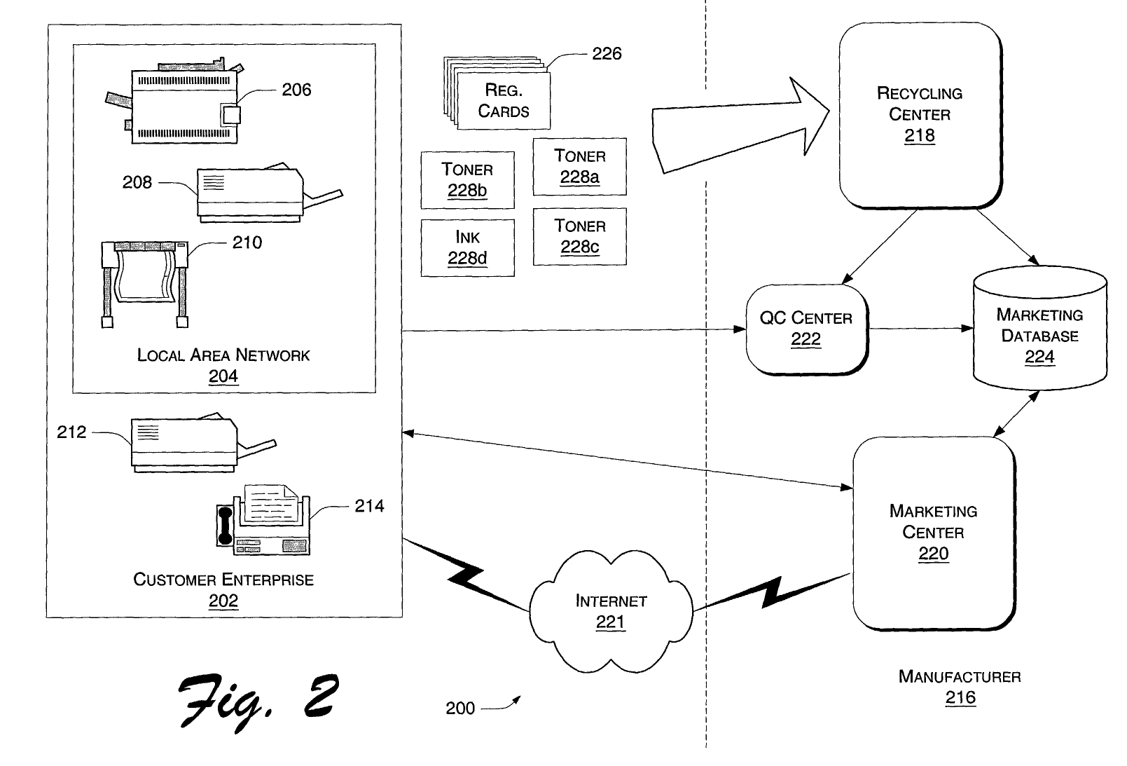

FIG. 2 is a diagram of an aggregation of systems 200 configured to employ the methods described herein. The systems 200 include a customer enterprise 202 that employs a local area network 204. The local area network 204 includes several computers (not shown) and printing devices, namely, laser printer 206, laser printer 208 and plotter 210. The customer enterprise 202 also includes laser printer 212 and fax machine 214 that are not a part of the local area network 204.

Although the customer enterprise 202 is shown having a local area network 240 and stand-alone printing devices, 212, 214, it is noted that any configuration of computers and printing devices that comprises at least one printing device may suffice for the purposes of the present invention. For example, the customer enterprise 202 could be a single person utilizing a single printing device. Or, the customer enterprise 202 could be a large enterprise having hundreds of computers and printing devices—networked and stand-alone. As the discussion progresses, it will be understood how one or more printing devices in the customer enterprise 202 can be utilized with the described methods.

The group of systems 200 also includes a manufacturer enterprise 216 that represents a manufacturer or vendor of printing devices and replaceable components for printing devices. The manufacturer enterprise 216 (or “manufacturer”) includes a recycling center 218 that receives depleted replaceable components, such as toner cartridges, from customers for recycling. The manufacturer 216 also includes a marketing center 220 that includes personnel and equipment used to identify potential customers and direct marketing strategies. In addition to connecting with customer via traditional communication means such as by telephone, the marketing center 220 communicates with the Internet 221. The marketing center 220 therefore can communicate with the customer enterprise 202 by way of the Internet 221.

The manufacturer enterprise has a quality control center 222 that receives depleted toner cartridges and other replaceable components from the recycling center 218 and customers having problems. Depleted replaceable components are checked according to a schedule set by the manufacturer 216, such as every n^{th} component, components that are suspected of having a higher than average defect rate, etc.

The manufacturer enterprise 216 maintains a marketing database 224 that stores customer information including, but not limited to, personal data, demographic data, printing devices purchased by multiple customers, replaceable components purchased by the customers, etc. In addition, the marketing database 224 stores usage information related to printing devices in which a customer utilizes a replaceable component that is returned to the recycling center 218. The quality control center 222 also stores findings related to testing of returned components in the marketing database 224. For instance, if a certain toner cartridge has been found to have a high rate of defects, that information might be stored with information related to printers that utilize that certain toner cartridge, which is ultimately linked with a customer who owns such a printer. The reason for doing so will be discussed in greater detail below.

When a printing device is sold by the manufacturer 216 to the customer enterprise 202 (“customer”), a registration or warranty card is included. The customer 202 fills out a registration card 226 for each printing device purchased by the customer 202. This information is stored in the marketing database 224 and includes a customer identifier that uniquely identifies the customer, such as a customer name or customer number. Thereafter, any information stored in the marketing database 224 that is related to the customer 202, printing devices owned by the customer 202, or replaceable components bought and/or returned by the customer are linked to the customer 202 by the customer identifier.

The registration card 226 may contain a box that the customer checks if the customer consents to receive future marketing information from the manufacturer 216. The marketing information may be advertisements for products that work with a product currently owned by a customer, for products to replace a current product owned by the customer, etc. The manufacturer 216 may desire to have the customer's permission to send certain advertisements rather than alienating a customer who does not desire to be on a marketing mailing list. Furthermore, a customer's privacy can be protected by not linking the customer's personal information with marketing solutions unless the customer has explicitly granted permission for the manufacturer to do so.

As the customer 202 uses toner cartridges 228a-228c, ink cartridge 228d, and other replaceable components (not shown), the cartridges 228a-228d are returned to the recycling center 218 of the manufacturer enterprise 216. Each cartridge 228a-228d includes a memory tag (FIG. 1, 108) integrated therewith or affixed thereto. Usage data from each printing device 206-214 is recorded in the memory of each cartridge 228a-228d as the printing device is operated with the cartridge installed. The recycling center 218 retrieves this data and stores the data in the marketing database 224. Thereafter, the cartridges 228a-228d may be sent to the quality control center 222 for testing.

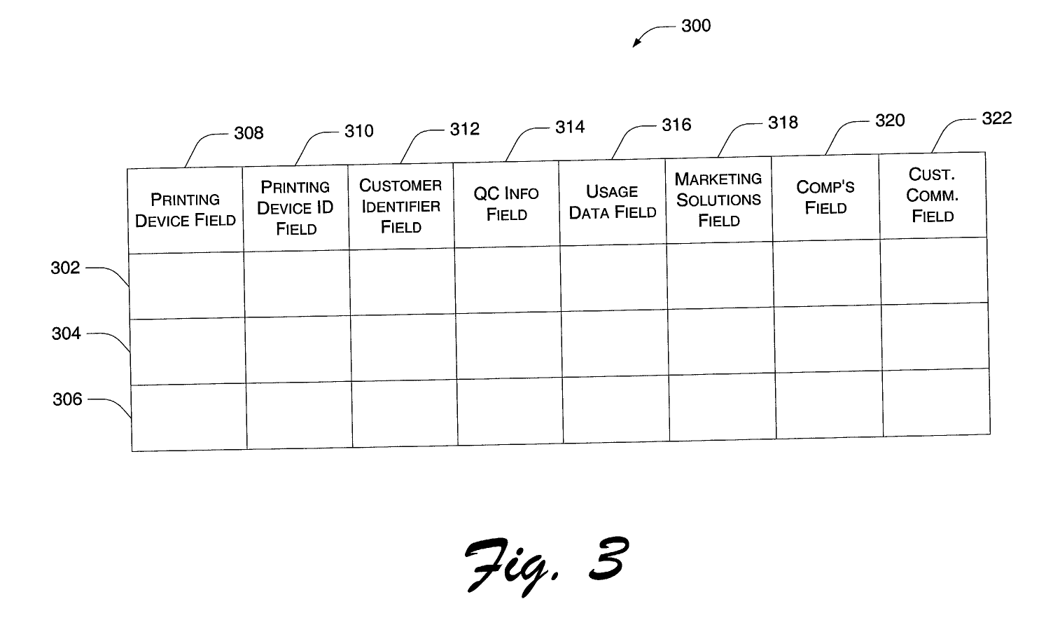

FIG. 3 is a representation of a marketing database 300 that is similar to the marketing database 224 shown in FIG. 2. The marketing database 300 includes multiple records, represented as record 302, record 304 and record 306. Although only three records are shown, it should be understood that the marketing database 300 may have virtually any number of records. Also, for discussion purposes, subsequent reference will be made only to record 302 as a matter of convenience. It should be understood that any field included in record 302 is also included in record 304, record 306 and any other record that may be included in the marketing database 300.

Record 302 includes a printing device field 308, a printing device identifier field 310, a customer identifier field 312, a quality control information field 314, and a usage data field 316. Record 302 also includes a marketing solutions field 318, a components field 320 and a customer communications field 322. The fields shown in record 302 are exemplary only and it should be noted that more or less fields may be utilized to accomplish the purposes described herein.

The printing device field 308 contains a value that uniquely identifies a type or model of a printing device. The printing device field 308 may contain a numerical value (model number) or an alphanumerical value, such as the model name of the printing device. As long as the value contained in the printing device field 308 can be used to uniquely identify a printing device, any value may be used.

The printing device identifier field 310 contains a value that uniquely identifies a single printing device of the type or model identified in the printing device field 308. Preferably, the printing device identifier field 310 contains the serial number of a printing device.

The customer identifier field 312 contains a value that uniquely identifies a customer. The value may be an alphanumeric value that represents a customer name, or the value may be a numerical value, such as a customer number that is assigned to the customer by the manufacturer. If a customer number is used, then other means must be used that allow the customer's name to be identified from the customer number.

The quality control information field 314 contains data collected by the quality control center 222 through product testing, returned products, customer complaints, etc., as to problems or defects seen in a particular product. For example, suppose that the quality control center 222 has determined that a “Model 930” laser printer exhibits above average wear on its photoelectric drum when the average page coverage printed from the printer exceeds 45%. This information would be stored in the quality control information field 314 of any record that contained a value for a “Model 930” laser printer in its printing device field. Later discussion will focus on how this information may be used in a marketing solution.

The usage data field 316 contains data retrieved from recycled replaceable components that have been used in (and, therefore, have collected data from) the printing device identified in the printing device identifier field 310. This information may include, but is not limited to, a number of pages printed by the printing device, percentage of black ink only jobs printed by the printing device, percentage of printing jobs printed in duplex mode, etc. Any printing device data that can be recorded and stored in the component memory of a replaceable component used in the printing device may be retrieved from the component memory and stored in the usage data field 316. Having access to this data helps to identify printing devices and, ultimately, customers that may be able to use other products offered by the manufacturer. Once such customers have been identified, a manufacturer can provide information about these other products to the customers.

The marketing solutions field 318 contains information that is used to identify printing devices that meet certain criteria. The marketing solutions field 308 may only contain criteria for a printing device identified in the printing device field 318 or the printing device identifier field 310. Additionally, the marketing solutions field 318 may contain criteria related to components used in the identified printing device. The components for a printing device identified in the printing device field 308 or the printing device identifier field 310 are identified in the components field 320. The components field 320 will be described in greater detail below.

As an example, suppose a laser printer “Model 100” is identified in the printing device field 308. Assume also that toner cartridges that have been used in the laser printer have been received by the recycling center 218 and usage data contained in the memory of those toner cartridges has been retrieved and stored in the marketing database 300. The usage data stored in the usage data field 316 may indicate that the number of pages printed by the laser printer in question is higher than the rated duty cycle for the laser printer. The marketing solutions field 318 may contain criteria that indicate that if a Model 100 printer is used to print more than x amount of pages in a month, then a printer with a higher duty cycle should be marketing to the owner of the Model 100 laser printer.

As another example, if the quality control information field 314 indicates that a toner cartridge designed for use in the Model 100 laser printer has been found to exhibit a high rate of defects, the marketing solutions field 318 may indicate that marketing information should be delivered to the customer who uses the laser printer. This marketing information may include a notice that the customer needs to start using a different toner cartridge, a coupon that the customer can use to obtain a discount on the new toner cartridge, advertising for the new toner cartridge and information about its superior performance, etc.

In one implementation, the criteria for determining when marketing should be targeted to the owner of a particular printing device is contained in the marketing solutions field 318. Every now and then, the database would be processed to take the criteria in the marketing solutions field 318 and apply the criteria to the information contained in the other fields. In an alternative implementation, only the instructions for what is to be done in a marketing sense is contained in the marketing solutions field 318. In that implementation, a query containing particular criteria for which to search would be run on the marketing database 300 whenever a database administration deems it to be appropriate.

The components field 320 contains information that identifies components that are used in the printing device identified in the printing device field 308 or the printing device identifier field 310. For instance, if a “Model 99” laser printer uses a 290A toner cartridge, that information is listed in the components field 320. It is noted that if the customer has only purchased components from the manufacturer, those components are listed in the components field 320 and the printing devices that utilize that component are identified in the printing device field 308.

The customer communications field 322 information related to communications with the customer that owns the identified printing device. This information may be a log of telephone calls, e-mail messages, correspondence, etc. This information can be used to evaluate the customer's attitude or likely attitude for receiving marketing, such as telephone calls. If the customer has a had a history of problems with a product, it may be decided that the customer wouldn't be receptive to some kinds of marketing techniques. Virtually any information related to the customer identified in the customer identification field 312 may be stored in the customer communications field 322.

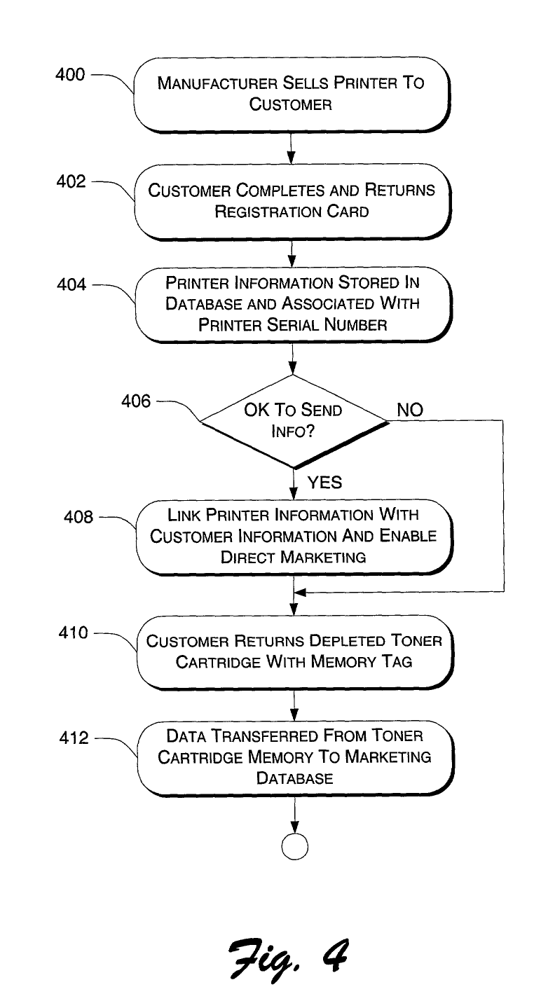

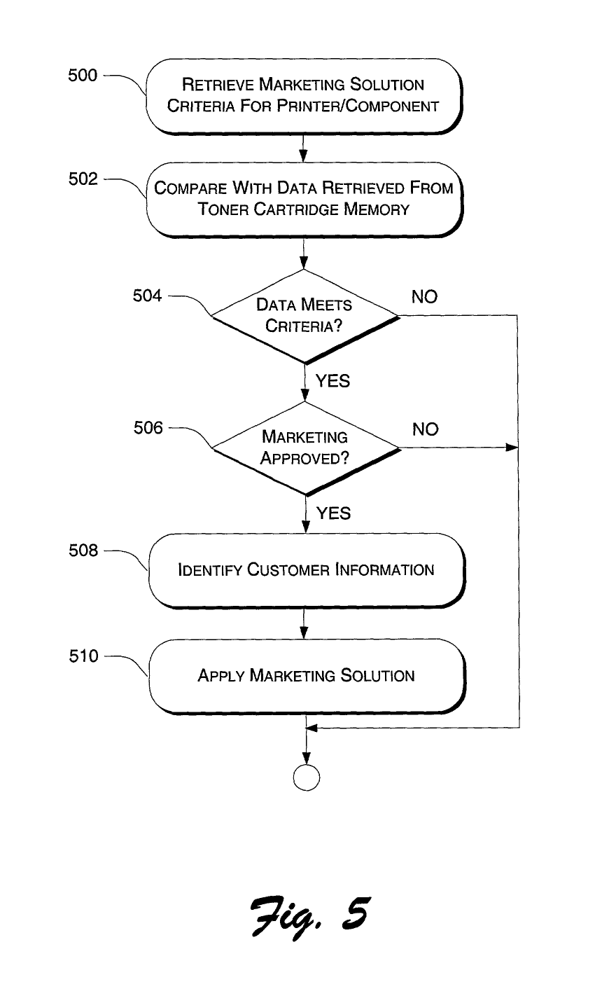

FIG. 4 is a flow diagram of one way in which the data retrieved from recycled component memory may be utilized in a marketing program. Continuing reference will be made to the elements and reference numerals of FIGS. 1-3 in the following discussion of FIG. 4 and FIG. 5.

At step 400, the manufacturer 216 sells a printer 206 (or some other printing device or printing device replaceable component) to the customer 202. The customer 202 completes a registration card 226 that is shipped with the printer 206 and returns the registration card 226 to the manufacturer 216 (step 402). Alternatively, some manufacturers provide a way in which a customer can register with the same information electronically, such as via the Internet. Any way in which the customer presents registration information to the manufacturer may be utilized. At step 404, the manufacturer 302 stores customer information from the registration card 226 in the marketing database 224. The customer information includes a printer identifier—such as a serial number—that uniquely identifies the printer 206 within the marketing database 224. All subsequent information entered into the marketing database 224 that is related to the printer 206 or a replaceable component purchased for the printer 206 is associated with the printer identifier.

At step 406, it is determined if the customer has agreed to allow the manufacturer to send marketing information about other manufacturer products to the customer. If so (“Yes, branch), step 406, then the printer identifier (serial number) is linked to customer information in the customer identifier field 312 and direct marketing is enabled. If, however, the customer does not authorize future marketing communications (“No” branch, step 406), then the information is not linked to the customer. One way that this can be done is simply to leave the customer identifier field 312 empty.

The printer 206 employs a toner cartridge 100 (or other replaceable component) that has a memory tag 108 affixed to the toner cartridge 100 or integrated into the toner cartridge 100. As the printer 206 operates, information related to the printer 206 and its usage is stored in the memory tag 108. This information includes printer usage data that includes, but is not limited to, total number of pages printed by the printer, number of pages printed from the toner cartridge 100, average amount of coverage on a page printed by the printer 206, percentage of print job that only use black ink, etc.

When the toner cartridge 100 runs out of toner, the customer 202 returns the depleted toner cartridge 100 to the manufacturer 216 for recycling at step 410. The recycling center 218 receives the toner cartridge 100 and, at step 412, retrieves the data from the memory tag 108 of the toner cartridge 100 and stores the data in the marketing database 224.

FIG. 5 is a flow diagram of a method for accessing the marketing database 224 to assist with identifying customers who meet certain criteria set forth by the manufacturer, the criteria determining if the customer is one to whom marketing information should be provided. At step 500, a marketing solution for a printer or component is retrieved. The marketing solution is information that identifies a situation that places a customer in a group to be targeted for specific marketing. For example, a marketing solution may be for any customer owning a certain type of laser printer and using more than one toner cartridge a month in the laser printer, to market a high-yield toner cartridge to the customer, the high-yield toner cartridge requiring replacement less frequently than the cartridge currently used by the customer.

There are alternative implementations for storing the marketing solutions information in the marketing database 224, 300. In a first implementation, the marketing solutions field may contain the marketing actions that are to take place if certain criteria are met for the printing device identified in the record. In such an implementation, a query containing the criteria would be run on the marketing database 224, 300. If the information in the record 302 matched the criteria set forth in the query, then the information contained in the marketing solutions field 318 would be applied or executed. In addition, in one implementation, the actual actions taken in response to identifying the printing device of the record 302 would also be stored in the marketing solutions field 318.

An alternative implementation for storing the marketing solutions information in the marketing database 224, 300 is to store the search criteria with the marketing actions to take place if the information in the record 302 meets the criteria. In such a case, the marketing database 224, 300 would have to be processed to apply criteria contained in the marketing solutions field 318 to the data contained in the other fields of the record 302. In printing device identified as meeting criteria stored in the marketing solutions field 318 would be subject to marketing focus.

Notwithstanding which implementation is utilized, at step 502 the criteria is compared with data that has been retrieved from the memory of toner cartridges returned to the manufacturer. This is the information that is stored in the various fields of the marketing database 300. At step 504, it is determined whether the data collected from a printing device meets the criteria set forth in the marketing solution. If it does not (“No” branch, step 504), then no further action is taken. If, however, the data meets the criteria (“Yes” branch, step 504), then it is determined if the customer who owns the identified printing device has authorized marketing materials to be delivered (step 506). If there is no such authorization (“No” branch, step 506), then no action is taken. If the customer has previously authorized the manufacturer to deliver marketing materials (“Yes” branch, step 506), then the customer is identified at step 508 and the marketing solution is applied at step 510. The application of the marketing solution is execution of the marketing plan that has been determined to be applicable to a printing device identified in the search. For example, a customer owning an identified printing device may receive a direct mailing, an e-mail message, a telephone call, etc.

Conclusion

The systems and methods described herein provide convenient, efficient ways for using data collected in memory of printing device replaceable components to identify marketing groups. The marketing groups so identified are a more focused potential customer group that has a higher likelihood of responding positively to marketing efforts. The customer is provided with a more satisfying ongoing relationship with the manufacturer since the manufacturer can assist the customer in obtaining the right printing device or printing device component for the way in which the customer uses a printing device.

1. A method, comprising:
retrieving printing device data from component memory on a replaceable component used in a printing device;
storing the printing device data in a marketing database;
associating the printing device data with the printing device;
searching the marketing database for a printing device that meets certain search criteria; and
applying a pre-determined marketing solution for a printing device found to meet the search criteria.

2. The method as recited in claim 1, wherein the applying a predetermined marketing solution further comprises notifying a customer that uses the printing device of a product that is related to the customer's use of the printing device.

3. The method as recited in claim 1, wherein the printing device data further comprises information regarding an environment of the printing device and the search criteria includes a printing device environment criterion.

4. The method as recited in claim 1, wherein the printing device data further comprises information regarding printing device usage and the search criteria includes a printing device usage criterion.

5. The method as recited in claim 4, wherein the search criteria further comprises a criterion that the printing device that is used with a specific component.

6. The method as recited in claim 1, wherein:
the marketing database further comprises quality control data that identifies problems with certain products when used under certain conditions; and
the search criteria comprises a product that is used under a condition identified by the quality control data.

7. The method as recited in claim 1, wherein the search criteria further comprises a particular type of printing device.

8. The method as recited in claim 1, wherein the search criteria further comprises a component of a particular type of printing device.

9. The method as recited in claim 1, wherein the printing device is a laser printer and the replaceable component is a toner cartridge.

10. The method as recited in claim 1, wherein the printing device is an inkjet printer and the replaceable component is an ink cartridge.

11. The method as recited in claim 1, wherein the marketing solution is stored in the marketing database and is associated with the printing device.

12. A system, comprising:
a marketing database that stores customer information for multiple customers, the customer information including information on printing devices and printing device replaceable components used by the customers;
a recycling center to receive a used printing device replaceable component with component memory from a printing device of a customer, and to retrieve printing device data from the component memory and store the printing device data in the marketing database; and
a marketing center configured to search the marketing database for printing devices having printing device data associated therewith that meet certain search criteria, and to apply marketing solutions for printing devices identified by a search.

13. The system as recited in claim 12, wherein applying marketing solutions for printing devices identified by a search further comprises identifying a customer that owns a printing device identified by a search and advertising a product to the customer that is related to the customer's use of the printing device.

14. The system as recited in claim 12, wherein:
the printing device data further comprises printing device usage data that indicates how the printing device was used when the replaceable component was installed in the printing device; and
the marketing center is further configured to search the marketing database for printing devices that meet specific usage criteria.

15. The system as recited in claim 12, wherein:
the marketing database further comprises quality control data that identifies situations with certain manufacturer products when used under certain conditions;
the printing device data further comprises printing device usage data that indicates how the printing device was used when the replaceable component was installed in the printing device; and
the marketing center is further configured to search the marketing database for printing devices that used under conditions identified as problematic by the quality control data.

16. The system as recited in claim 12, wherein the printing devices further comprise laser printers and wherein the printing device replaceable components further comprise toner cartridges.

17. A method for marketing products to customers, comprising:
searching a marketing database for a printing device or printing device replaceable component that meets certain search criteria, the marketing database storing printing device data that has been retrieved from component memory of a printing device replaceable component used in a printing device;
identifying a customer that uses the printing device; and
distributing marketing information to the customer, the marketing information advertising products associated with customer use of the printing device or printing device replaceable component.

18. The method as recited in claim 17, wherein:
the printing device data further comprises usage data; and
the search criteria further comprises one or more usage criteria.

19. The method as recited in claim 17, wherein:
the printing device data further comprises usage data;
the marketing database further comprises quality control data that indicates problems that may occur when certain printing devices are used under certain conditions; and
the search criteria further comprises a printing device that is used under conditions proscribed by the quality control data.

20. The method as recited in claim 17, wherein the printing device further comprises a laser printer, and wherein the printing device replaceable component further comprises a toner cartridge.

21. A marketing database stored on one or more computer-readable media, the database comprising a plurality of records, each record further comprising:
a product identifier field that contains a value that uniquely identifies a product;
a customer identifier field that contains a value that uniquely identifies a customer that uses the product identified in the product identifier field;
a usage data field that contains usage data that indicates how the product identified in the product identifier field is used by the customer identified in the customer identifier field; and
a marketing solution field that contains a marketing solution that is to be applied to the customer identified in the customer identifier field if the usage data meets certain usage criteria.

22. The marketing database as recited in claim 21, wherein the usage criteria is contained in the marketing solution field.

23. The marketing database as recited in claim 21, further comprising a product identifier field that contains a value that uniquely identifies a type of product.

24. The marketing database as recited in claim 21, further comprising a quality control information field that contains information that indicates usage conditions under which the product may malfunction.

25. The marketing database as recited in claim 21, wherein:
the product field further comprises a printer field that identifies a model of printer;
the product identifier field further comprises a printer identifier field that is a serial number that uniquely identifies a printer of the model indicated in the printer field;
the usage data field contains data that indicates how the printer identified by the serial number in the printer identifier field is used, the usage data being collected from memory of a replaceable component that has been used in the printer identified by the serial number in the printer identifier field.
